(19) United States
(12) Patent Application Publication
(10) Pub. No.: US 2007/0118760 A1
(43) Pub. Date: May 24, 2007

(54) Image processor, job log creating method, and storage medium

(76) Inventor: Takanori Masui, Ebina-shi (JP)

Correspondence Address: GAUTHIER & CONNORS, LLP, 225 FRANKLIN STREET, SUITE 2300, BOSTON, MA, 02110, US

(21) Appl. No.: 11/394,313

(22) Filed: Mar. 30, 2006

(30) Foreign Application Priority Data
Nov. 21, 2005 (JP) 2005-335566

(51) Int. Cl. G06F 12/14

(52) U.S. Cl. 713/189

(57) ABSTRACT

An image processor has a job processing unit, a log creating unit and a log encrypting unit. The job processing unit applies a job process. The log creating unit creates a job log including image data representing an image to which the job process is applied. The log encrypting unit applies an encryption process to the created job log in a manner to allow decoding by a predetermined inspector and stores in a log storage unit an encrypted log obtained as a result of the encryption process.

### PRIORITY INFORMATION

This application claims priority to Japanese Patent Application No. 2005-335566, filed on Nov. 21, 2005, which is incorporated herein by reference in its entirety.

### BACKGROUND

1. Technical Field

The present invention relates to an image processor which performs job processes, and particularly to an image processor which creates a job log including image data representing an image to which a job process is applied and stores the job log in a log storage unit.

2. Related Art

Recently, there is increasing consciousness regarding preventing leakage of confidential information such as personal information and in-house information in business organizations, etc. Regarding an image processor which also applies a job process such as copying and scanning of an image, leakage of information which is indicated in an image must be prevented.

### SUMMARY

An image processor has a job processing unit, a log creating unit and a log encrypting unit. The job processing unit applies a job process. The log creating unit creates a job log including image data representing an image to which the job process is applied. The log encrypting unit applies an encryption process to the created job log in a manner to allow decoding by a predetermined inspector and stores in a log storage unit an encrypted log obtained as a result of the encryption process.

### BRIEF DESCRIPTION OF THE DRAWINGS

Embodiments of the present invention will be described in detail by reference to the drawings, wherein:

FIG. 1 is a diagram showing an overall system structure of monitoring systems according to an embodiment and first and second alternative embodiments of the present invention;

FIG. 2 is a diagram showing functional blocks of image processors according to the embodiment and the first and second alternative embodiments;

FIG. 3A is a diagram exemplifying a job log created by an image processor;

FIG. 3B is a diagram exemplifying another job log created by an image processor;

FIG. 4 is a flowchart showing processes executed by an image processor according to the embodiment;

FIG. 5 is a flowchart showing processes executed by an image processor according to the first alternative embodiment;

FIG. 6 is a flowchart showing processes executed by an image processor in a configuration for handling a case when an image to be transmitted to a viewer is encrypted by means of a public key of the viewer in the second alternative embodiment; and

FIG. 7 is a flowchart showing processes executed by an image processor when an image to be transmitted to a viewer is encrypted by means of an encryption password of the viewer in the second alternative embodiment.

### DETAILED DESCRIPTION

An embodiment of the present invention will now be described by reference to the drawings.

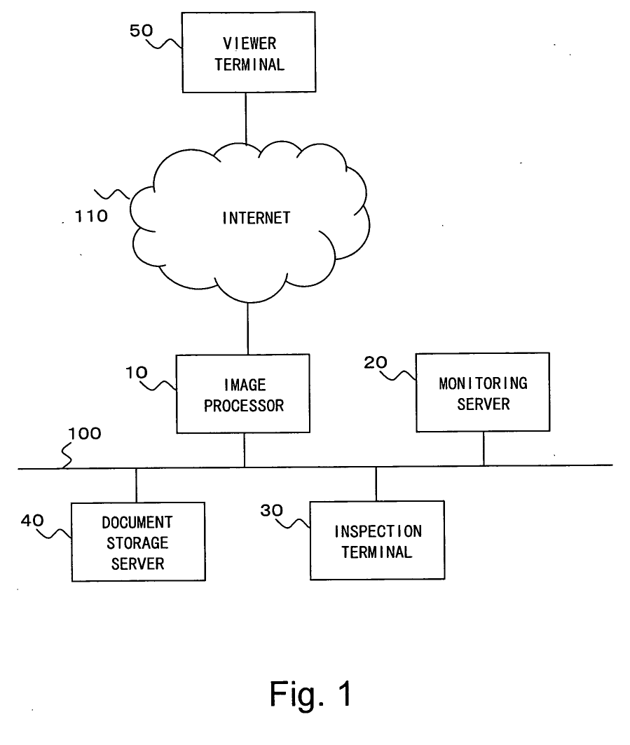

FIG. 1 is a diagram showing an overall system structure of a monitoring system according to an embodiment of the present invention. The monitoring system comprises two networks including a local area network (LAN) 100 and the Internet 110. The monitoring system further comprise an image processor 10, a monitoring server 20, an inspection terminal 30, a document storage server 40, and a viewer terminal 50-1 (not shown) which is connected to the LAN 100 and a viewer terminal 50 (terminal 50-2) which is connected to the Internet 110. The viewer terminals 50-1 and 50-2 will hereinafter be referred to as a “viewer terminal 50” unless the terminals 50-1 and 50-2 must be distinguished.

The image processor 10 applies a job process. The job processes include a scanning process in which a document designated by a user is electronically read to create an electronic image (hereinafter simply referred to as an “image”) and a printing process in which an image designated by a user is printed on paper. A copy process in which an image obtained by a scanning process is printed on paper is also one of the job processes. In addition, a process of transmitting an image to the viewer terminal 50 by attaching the image to an electronic mail or via facsimile transmission and a process of storing the image in the document storage server 40 are also examples of the job processes applied by the image processor 10.

In order to prevent leakage of information due to these job processes applied by the image processor 10, the image processor 10 creates a job log including image data representing each image to which various job processes are applied and transmits the job log to the monitoring server 20. An inspector accesses the monitoring server 20 via the inspection terminal 30 to refer to the job log so that the inspector can check the contents of the image to which a job process is applied. Thus, the inspector can perceive a possible information leakage that may take place due to a job process applied by the image processor 10 by referring to the job log or to trace and examine a cause of information leakage by referring to the job log.

The image data representing the image to which the job process is applied are image data which include information indicated in the image. The image data are also data with which the inspector can check what information is indicated in the image to which the job process is applied. For example, the image data may be an image itself obtained by electronically reading a document, a thumbnail image in which the image is reduced, or an enlarged image in which the image is enlarged. Therefore, if a user can refer to the job log, the user can check the information indicated in the image to which the job process is applied. Because of this, when a user other than the inspector accesses the monitoring server 20 and refers to the job log stored in the monitoring server 20, the information leaks. Such an information leakage may occur even when the job log is transmitted and received by the image processor 10 and the monitoring server 20 by means of an encryption protocol such as SSL, because the job log itself is not encrypted.

In consideration of the above, in the embodiment, the image processor 10 applies an encryption process to the job log in such a manner to allow decoding only by a predetermined inspector and stores the encrypted log obtained as a result of the encryption process in the monitoring server 20.

The image processor 10 will now be described in more detail.

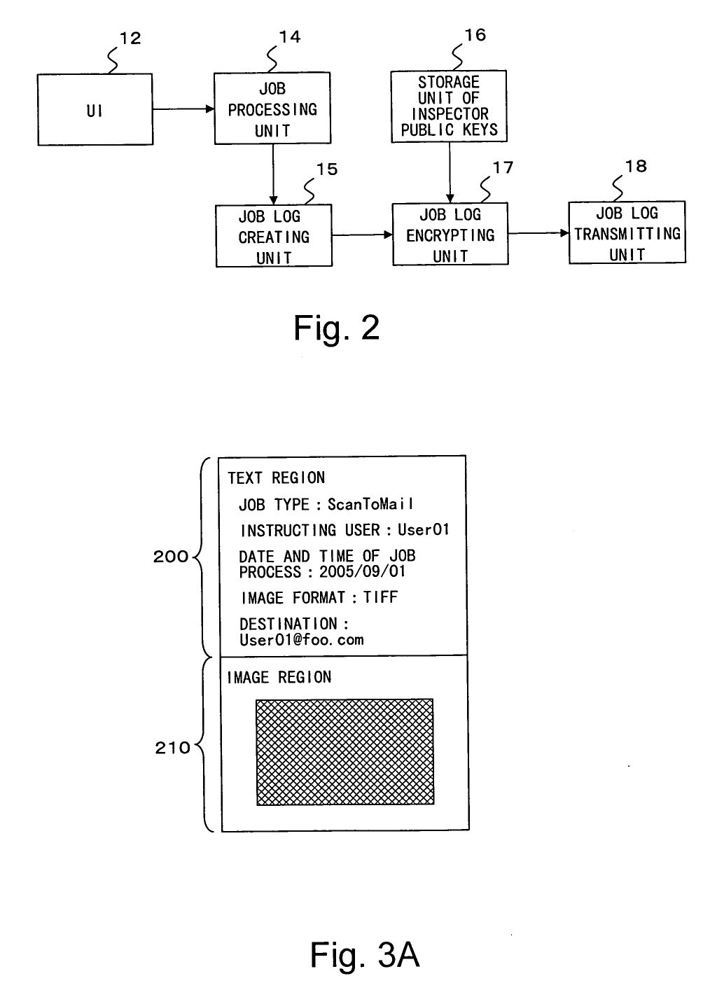

FIG. 2 is a diagram showing functional blocks of the image processor 10. In FIG. 2, a user interface (UI) 12 is an operation unit used by the user to instruct the image processor 10 to apply a desired job process. A job processing unit 14 applies various job processes on the basis of an instruction received via the UI 12 and the network.

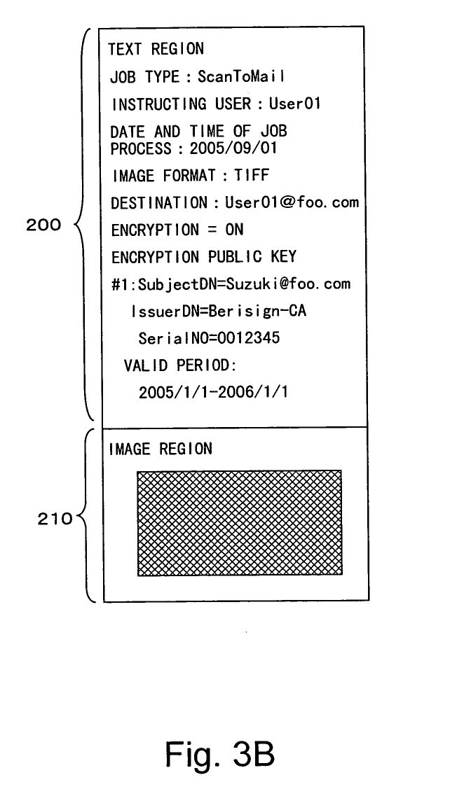

A job log creating unit 15 creates a job log including image data representing an image to which the job process is applied. FIG. 3A is a diagram exemplifying a job log. As shown in FIG. 3A, the job log comprises a text region 200 and an image region 210. In the text region 200 is stored information such as a type of the applied job process, identification information of the user instructing the application of the job process, date and time of execution of the job process, an image format of the image to which the job process is applied, etc. When the job process is a process to transmit the image to a destination of a viewer, information of the destination is also shown. When the image processor 10 or the monitoring server 20 has a character recognition (OCR) capability, a text string recognized within the image may be included in the text region 200 as a search keyword. In the image region 210, an image to which the job process is applied, or a thumbnail image or an enlarged image of this image is shown as image data.

A storage unit of inspector public keys 16 stores a public key for inspector used for encryption in a manner to allow decoding of the job log by only the inspector. A public key is one of a pair of keys used in a public key encryption and is made public. The public key of the inspector may be obtained from an authorization agency and registered in advance in the storage unit of inspector public keys 16.

A job log encrypting unit 17 obtains the public key of the inspector from the storage unit of inspector public keys 16, applies an encryption process to the job log created by the job log creating unit 15 by means of the public key, and creates an encrypted log. The job log encrypting unit 17 applies the encryption process at least to the image region 210. The job log encrypting unit 17 may alternatively apply the encryption process to the entire job log. When the job log encrypting unit 17 can distinguish the information indicated in the image data included in the job log into private information and public information, the job log encrypting unit 17 may at least apply the encryption process only to a region corresponding to the private information.

A job log transmitting unit 18 transmits the encrypted log to the monitoring server 20. The monitoring server 20 has a database for storing the job log, and stores the encrypted log transmitted from the image processor 10 in the database.

In this manner, in the present embodiment, the image processor 10 applies an encryption process to the created job log by means of the public key of the inspector and stores in the monitoring server 20 the encrypted log obtained as a result of the encryption process. With this structure, even when a third party accesses the monitoring server 20 through an unauthorized access and obtains the job log, because the job log is encrypted in such a manner to allow decoding by only the inspector who has the private key, the third party cannot view the image data included in the job log. Therefore, even when the job log is accessed through an unauthorized access, leakage of information can be prevented.

Because the job log stored in the monitoring server 20 can be decoded only by the inspector, even when there are other users who can access the monitoring server 20, the other users cannot refer to the contents of the job log. Therefore, the security with respect to the job log can be improved.

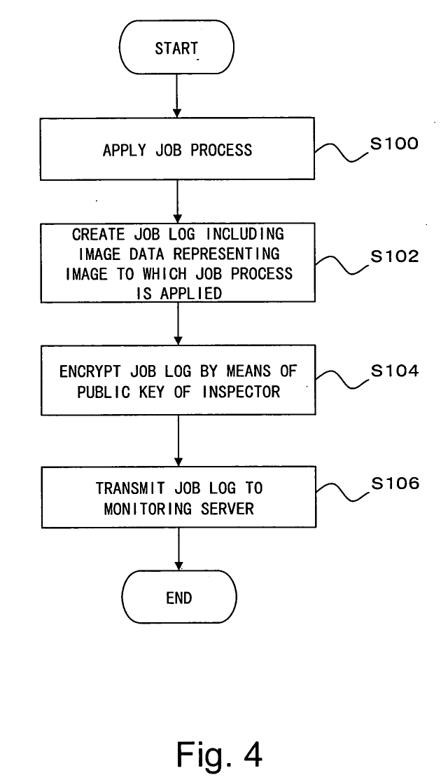

Processing of the image processor 10 when the image processor 10 applies a job process according to an instruction by a user will now be described by reference to a flowchart of FIG. 4.

The image processor 10 applies a job process such as a scanning process of a document, in accordance with an instruction from a user (S100). The image processor 10 also creates a job log including the image data representing an image to which the job process is applied (Sl02). For example, the image processor 10 creates a thumbnail image of an image obtained by scanning a document and embeds the thumbnail image in the image region 210 of the job log. The image processor 10 then provides information for specifying the user who has instructed the job process (such as, for example, user name and user ID), a type of the job process, etc. on the text region 200 of the job log.

Next, the image processor 10 applies an encryption process to the created job log by means of a public key of the inspector (S104). Then, the image processor 10 transmits the encrypted job log (encrypted log) to the monitoring server 20 (S106).

With the above-described process, job logs that can be decoded only by the inspector are stored in the monitoring server 20. Therefore, even when the job log stored in the monitoring server 20 is accessed through unauthorized access, leakage of information can be prevented. In addition, because the job log stored in the monitoring server 20 can be decoded only by the inspector, even when there are other users who can access the monitoring server 20, the other users cannot refer to the contents of the job log. Thus, the security with respect to the job log can be improved.

In the above-described embodiment, a configuration is described in which the job log encrypting unit 17 encrypts the job log through the public key encryption method. However, the present invention is not limited to such a configuration, and the job log may be encrypted through a method other than the public key encryption, so long as the method allows encryption in a manner to allow decoding only by the inspector. For example, the job log encrypting unit 17 may encrypt the job log by means of an encryption password which is known only to the inspector.

In the above-described embodiment, a configuration is described in which there is only one inspector. When more than one inspector is present, the image processor 10 encrypts the job log such that the job log can be decoded by each inspector. More specifically, the image processor 10 first creates a contents encryption key (random number) for encrypting the job log. The image processor 10 then encrypts the job log by means of the contents encryption key, encrypts the contents encryption key by means of the public key of each inspector, and transmits each encrypted contents encryption key to the monitoring server 20 in association with the encrypted job log. In this manner, the job log can be encrypted in a manner to allow decoding by each inspector.

A first alternative embodiment will now be described.

The first alternative embodiment can be desirably applied to a case when the image processor 10 transmits, to a destination of designated viewer, an image to which the job process is applied wherein the transmitted image is encrypted by means of the public key of the viewer to allow decoding by the viewer.

Conventionally, even when the image to be transmitted to a viewer has been encrypted by means of the public key of the viewer, information regarding the public key used in the encryption has not been managed as a log. Because of this, even when the information on the image transmitted from the image processor 10 has leaked due to, for example, leakage of the private key of the viewer, the inspector has not been able to trace and examine whether or not the image has actually been encrypted or whether or not there has been applied encryption using a public key which was valid at the time of transmission of the image. Because it has not been possible to trance whether or not the image encrypted by means of a public key and then transmitted actually exists, when the viewer is registered in a certification rejection list (CRL) because of leakage of the private key of the viewer or the like, the inspector has not been able to identify whether or not there is an image which is encrypted by means of the public key corresponding to the private key in the past and to identify to which viewer the image encrypted using the public key is transmitted, and thus, it has not been possible to prevent spread of the leakage of information.

In consideration of this, in the first alternative embodiment, when the image to be transmitted to a viewer is encrypted by means of a public key of the viewer, the image processor 10 transmits information regarding the public key (hereinafter referred to as “public key information”) to the monitoring server 20 along with the encrypted log. The monitoring server 20 associates the encrypted log and the public key information transmitted from the image processor 10 and stores this information in the database.

Here, the public key information is information used by the inspector for tracing and investigating security regarding an image encrypted using the public key and is, for example, information described in an electronic certificate such as the algorithm and key length of the public key, the serial number of the certificate, information of the authority issuing the certificate, and the valid period of the certificate. Therefore, by referring to the job log and the public key information, the inspector can understand whether or not there is an image encrypted by means of a public key or to which viewer the image encrypted using the public key is transmitted. In addition, the inspector can understand whether or not the public key used in the encryption of the image was a valid public key at the time of encryption. The image processor 10 may add the public key information to the text region 200 of the job log and transmit the job log to the monitoring server 20. FIG. 3B exemplifies a case in which the public key information is added to the text region 200 of the job log.

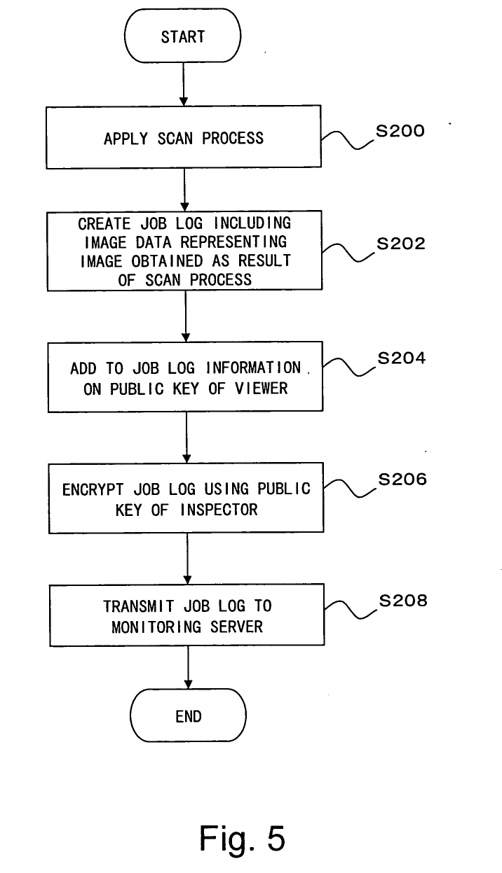

Processing when the image processor 10 scans a document in response to an instruction from a user and transmits the obtained image to a designated destination of a viewer in the first alternative embodiment will now be described by reference to a flowchart of FIG. 5.

First, the image processor 10 executes a scanning process of the document in response to the instruction from the user (S200). Then, the image processor 10 creates the job log in a manner similar to the above-described embodiment (S202). Next, the image processor 10 obtains public key information of the public key of the viewer to be used for encryption of the image and adds the public key information to the text region 210 of the job log (S204). The image processor 10 then encrypts the job log by means of the public key of the inspector (S206) and transmits the encrypted log to the monitoring server 20 (S208).

As described, according to the first alternative embodiment, when the image processor 10 encrypts an image by means of the public key of the viewer when the image is transmitted to the viewer, the image processor 10 transmits the public key information of the public key to the monitoring server 20 along with the encrypted log. Therefore, by referring to the job log and the public key information, the inspector can understand whether or not there is an image encrypted by means of the public key or to which viewer an image encrypted by means of the public key is transmitted. In addition, the inspector can understand whether or not the public key used in the encryption of the image is a public key which was valid at the time of encryption.

In the first alternative embodiment, a configuration has been described in which the public key information of the public key of the viewer used in the encryption of the image is transmitted to the monitoring server 20 in association with the job log. However, it is only necessary that the inspector can understand which public key was used in encrypting the transmitted image. Therefore, there may also be employed a configuration in which the image itself encrypted by means of the public key of the viewer is transmitted to the monitoring server 20 in association with the job log and this information is stored in the monitoring server 20. In this configuration also, the inspector can obtain the public key information of the public key of the viewer by referring to the image encrypted by means of the public key of the viewer. Therefore, the inspector can understand whether or not the public key used in the encryption of the image is a public key which was valid at the time of the encryption.

A second alternative embodiment will now be described.

In the second alternative embodiment, when the image processor 10 encrypts and transmits an image to a viewer, the image processor 10 encrypts the image so that the encrypted image can be decoded not only by the viewer, but also by the inspector.

When the image processor 10 encrypts, by means of a public key of the viewer, an image obtained by, for example, scanning a document and transmits the encrypted image to the viewer, the transmitted image cannot be decoded unless the private key of the viewer is used. However, there may be cases in which the inspector must decode the transmitted image and investigate in order to trace and investigate information leakage. In such cases, the transmitted image cannot be decoded if the inspector cannot obtain the private key of the viewer, and, thus, the tracing and investigation of the information leakage may be impeded.

In consideration of this, in the second alternative embodiment, the image processor 10 encrypts the image to be transmitted in such a manner to allow the inspector to decode the image transmitted to the viewer even when the viewer loses the private key or the viewer refuses to provide the private key to the inspector. More specifically, the image processor 10 transmits to the viewer an encrypted key in which the contents encryption key used in encrypting the image is encrypted by means of the public key of the viewer and an encrypted key in which the same contents encryption key is encrypted by means of the public key of the inspector, in association with the image. In this manner, the image transmitted to the viewer can be decoded by the viewer and also by the inspector.

The image processor 10 may add to the job log the public key information of the public key of the inspector used in the encryption of the image to be transmitted to the viewer.

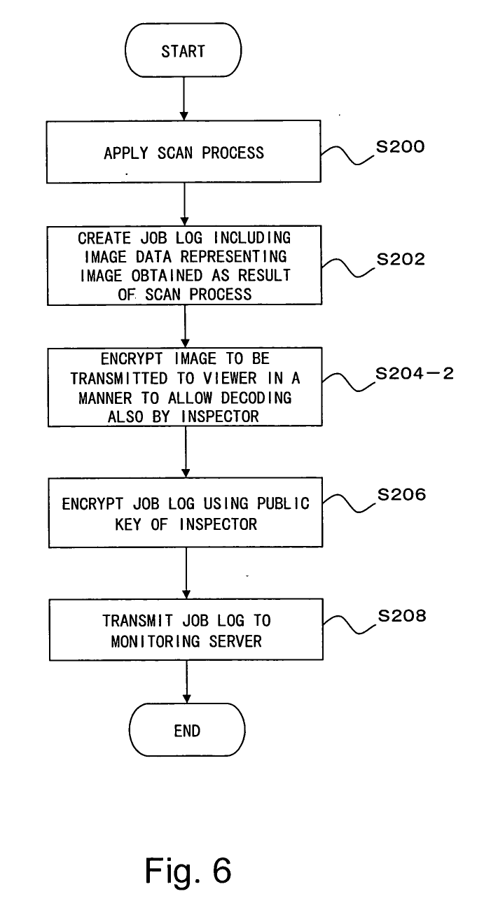

FIG. 6 is a flowchart showing processing when the image processor 10 according to the second alternative embodiment transmits to a viewer an image obtained as a result of the scanning process.

As shown in FIG. 6, the image processor 10 of the second alternative embodiment applies an encryption to an image obtained as a result of the scanning process in such a manner that the inspector can decode the encrypted image in addition to the viewer (S204-2). The creation of the job log is similar to that in the image processor 10 of the embodiment or the first alternative embodiment and will not be described again.

As described, according to the second alternative embodiment, when encryption is applied to an image to be transmitted to a viewer, even when the viewer loses the private key or refuses to provide the private key to the inspector, the inspector can easily decode the image transmitted to the viewer.

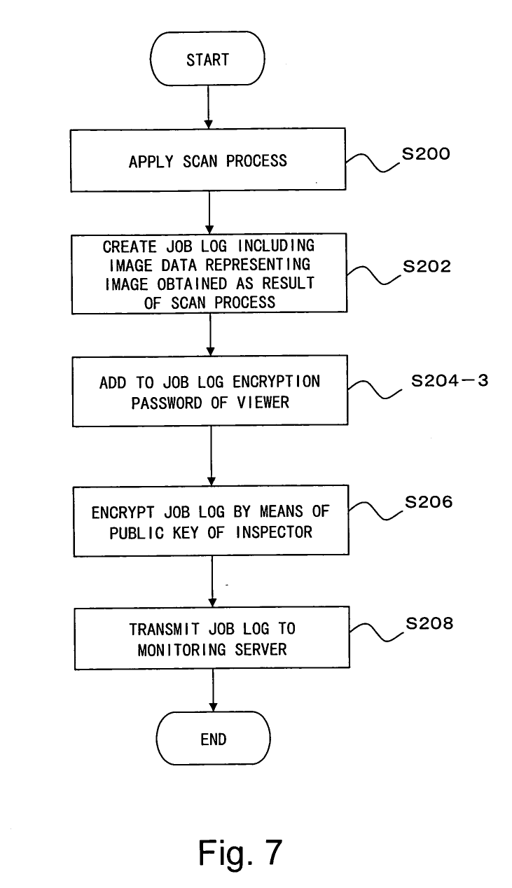

In the second alternative embodiment, a case is described in which the image processor 10 encrypts the image by means of the public key of the viewer. However, as described above, in some cases, the image processor 10 may encrypt the image by means of an encryption password for the viewer. In this case, as shown in the flowchart of FIG. 7, the image processor 10 writes, in the text region 200 of the job log, the encryption password for the viewer used in the encryption of the image (S204-3) and transmits the encrypted job log to the monitoring server 20 (S208). In this manner, the inspector can obtain the encryption password for the viewer by referring to the job log, and, thus, can easily decode the image transmitted to the viewer even when the viewer forgets the encryption password or refuses to provide the encryption password to the inspector.

In the above-described embodiment and first and second alternative embodiments, the image processor 10 and the monitoring server 20 are described as separate devices. Alternatively, it is also possible to add a function of the monitoring server 20 in the image processor 10. That is, the job log can be stored in a database of the image processor 10.

The image data contained in the job log may be the image itself to which the job process is applied, or a reduced image (thumbnail image) or an enlarged image of the image. The log encrypting section may apply the encryption process at least with respect to the image data.

According to one aspect of the present invention, it is desirable that, in the image processor, the job process is a process of transmitting the image to a designated viewer destination, the job processor further comprises an image encrypting unit that applies an encryption process using a public key of the viewer on an image to be transmitted by the job processing unit, and the log encrypting unit stores in the log storage unit information related to the public key in association with the encrypted log. The information related to the public key is information used by the inspector for tracing and investigation on security with respect to the image encrypted by means of the public key, and is, for example, information described in a public key certificate such as algorithm and key length of the public key, a serial number of the certificate, information on the authority issuing the certificate, and the valid period of the certificate.

According to another aspect of the present invention, it is desirable that, in the image processor, the job process is a process of transmitting the image to a designated viewer destination, the job processor further comprises an image encrypting unit that applies an encryption process using a public key of the viewer on an image to be transmitted by the job processing unit, and the log encrypting unit stores in the log storage unit the image to which the encryption process is applied by means of the public key of the viewer, in association with the encrypted log.

According to another aspect of the present invention, it is desirable that, in the image processor, the job process is a process of transmitting the image to a designated viewer destination, the job processor further comprises an image encrypting unit that applies an encryption process using an encryption password for the viewer on an image to be transmitted by the job processing unit, and the log encrypting unit stores in the log storage unit the encryption password in association with the encrypted log.

According to another aspect of the present invention, it is desirable that, in the image processor, the job process is a process of transmitting the image to a designated viewer destination and the image processor further comprises an image encrypting unit that applies an encryption process on an image to be transmitted by the job processing unit in a manner to allow decoding by the viewer and by the inspector.

What is claimed is:

1. An image processor comprising:
a job processing unit that applies a job process;
a log creating unit that creates a job log including image data representing an image to which the job process is applied; and
a log encrypting unit that applies an encryption process to the created job log in a manner to allow decoding by a predetermined inspector and stores in a log storage unit an encrypted log obtained as a result of the encryption process.

2. The image processor according to claim 1, wherein
the job process is a process of transmitting the image to a designated viewer destination;
the image processor further comprises an image encrypting unit that applies an encryption process using a public key of the viewer on an image to be transmitted by the job processing unit; and
the log encrypting unit stores in the log storage unit information related to the public key in association with the encrypted log.

3. The image processor according to claim 1, wherein
the job process is a process of transmitting the image to a designated viewer destination;
the image processor further comprises an image encrypting unit that applies an encryption process using a public key of the viewer on an image to be transmitted by the job processing unit; and
the log encrypting unit stores in the log storage unit the image to which the encryption process is applied by means of the public key of the viewer, in association with the encrypted log.

4. The image processor according to claim 1, wherein
the job process is a process of transmitting the image to a designated viewer destination;
the image processor further comprises an image encrypting unit that applies an encryption process using an encryption password for the viewer on an image to be transmitted by the job processing unit; and
the log encrypting unit stores in the log storage unit the encryption password in association with the encrypted log.

5. The image processor according to claim 1, wherein
the job process is a process of transmitting the image to a designated viewer destination; and
the image processor further comprises an image encrypting unit that applies an encryption process on an image to be transmitted by the job processing unit in a manner to allow decoding by the viewer and by the inspector.

6. An image processing method for processing an image comprising:
creating a job log including image data representing the image to be processed;
applying an encryption process to the created job log in a manner to allow decoding by a predetermined inspector; and
storing in a log storage unit an encrypted log obtained as a result of the encryption process.

7. A storage medium readable by a computer, the storage medium storing a program of instructions executable by the computer to perform a function, the function comprising:
applying a job process;
creating a job log including image data representing an image to which the job process is applied; and
applying an encryption process to the created job log in a manner to allow decoding by a predetermined inspector; and
storing in a log storage unit an encrypted log obtained as a result of the encryption process.
